(19) United States
(12) Patent Application Publication
(10) Pub. No.: US 2017/0125945 A1
(43) Pub. Date: May 4, 2017

(54) PIN CONNECTOR

(71) Applicant: JETMAX LIGHTING COMPANY LIMITED, Dongguan City (CN)

(72) Inventor: Yang Ping, Dongguan City (CN)

(21) Appl. No.: 15/337,738

(22) Filed: Oct. 28, 2016

(30) Foreign Application Priority Data
Oct. 29, 2015 (CN) 201520862024.8

(51) Int. Cl. H01R 13/631; H01R 13/05

(52) U.S. Cl. CPC H01R 13/631; H01R 13/052

(57) ABSTRACT

The present invention discloses a pin connector including a male connector and a female connector, whereby the male connector is inserted into the female connector and is electrically connected to the female connector. A first connecting portion is provided at a connecting end of the male connector, a second connecting portion matching the first connecting portion is provided at a connecting end of the female connector; an external circumferential wall of the housing of the male connector and an external circumferential wall of the housing of the female connector are respectively provided with a first limiting portion and a second limiting portion to facilitate the connection of the first connecting portion and the second connecting portion. The male connector and female connector can be easily connected and installed effectively improving the connecting efficiency and avoiding unnecessary metal contact damage, so as to increase the connector's service life.

### CROSS-REFERENCE TO RELATED APPLICATIONS

This application claims the benefit of Chinese Patent Application Number 201520862024.8, filed Oct. 29, 2015. The disclosure of the above application is incorporated herein by reference.

### TECHNICAL FIELD

The present invention relates to the technical field of electric connectors; more specifically, it relates to a pin connector used for Christmas tree assembly.

### BACKGROUND

With the spread of Christmas culture, artificial Christmas trees with light decoration become widely used decorations to increase the holiday atmosphere. The Christmas trees available on the market are typically formed by various parts including a trunk, branches, wires and decoration lights connected by wires, which can be manually assembled together. In order to avoid the problems associated with a very long wire, multiple shorter wires with connectors are usually used.

A wire is introduced from the bottom of the trunk, which then comes out from a side of the trunk, and the wire is next connected to another wire via connectors. A male connector and a female connector are provided at the connecting location of two adjacent trunk sections, wherein the male connector is located on the inner wall of one trunk section, and the female connector is located on the inner wall of the other trunk section; and the wires are connected at the connecting location of the two adjacent trunk sections via the male connector and the female connector.

In the existing technologies, when the male connector and the female connector are connected together, due to the lack of a guiding structure, it is inconvenient to connect the male connector and the female connector together, since it is hard to accurately insert each metal contact on the male connector into the corresponding holes on the female connector. As a result, the installation efficiency is pretty low; and it is pretty easy to damage metal contacts, which will reduce the service life of the connectors.

### BRIEF SUMMARY

The object of the present invention is to overcome the deficiencies in the prior art and provide a pin connector, in which the male connector and female connector can be easily connected, which can effectively improve the connecting efficiency between the male connector and the female connector. They can be easily installed; and at the same time, the present invention can avoid unnecessary metal contact damage, so as to increase the connector's service life.

The technical solution employed in the present invention is as follows: a pin connector, comprising a male connector, which is provided with a plurality of metal contacts; a female connector, which comprises a plurality of holes corresponding to the plurality of metal contacts, wherein the male connector is inserted into the female connector, and the male connector is electrically connected to the female connector; wherein a first connecting portion is provided at a connecting end of the male connector, a second connecting portion matching the first connecting portion is provided at a connecting end of the female connector; the external circumferential wall of the housing of the male connector and the external circumferential wall of the housing of the female connector are respectively provided with a first limiting portion and a second limiting portion to facilitate the connection of the first connecting portion and the second connecting portion.

Preferably, in the technical solution set forth above, the first limiting portion and the second limiting portion are straight slots respectively formed on the external circumferential wall of the housing of the male connector and the external circumferential wall of the housing of the female connector.

Preferably, in the technical solution set forth above, the first limiting portion and the second limiting portion are straight protrusions respectively formed on the external circumferential wall of the housing of the male connector and the external circumferential wall of the housing of the female connector.

Preferably, in the technical solution set forth above, the first connecting portion is a connecting block formed on the internal circumferential wall of the connecting end of the male connector and extended in an axial direction, and at least one connecting block is fixedly provided on the internal circumferential wall of the connecting end of the male connector.

Preferably, in the technical solution set forth above, the second connecting portion is a connecting slot formed on the external circumferential wall of the connecting end of the female connector and extended in an axial direction, and at least one connecting slot is provided on the external circumferential wall of the connecting end of the female connector.

Preferably, in the technical solution set forth above, mounting holes are respectively provided on the housing of the male connector and the housing of the female connector, wherein the mounting holes are used for detachably mounting the male connector and the female connector on a tree trunk.

The beneficial effects of the present invention are as follows:

1) A first limiting portion and a second limiting portion are respectively provided on the external walls of the housing of the male connector and the housing of the female connector. By virtue of the first limiting portion and the second limiting portion, the present invention is able to ensure that the first connecting portion can be easily inserted into the second connecting portion, which further ensures that the metal contacts are accurately inserted into the corresponding holes. In this way, it is able to improve the connecting efficiency between the male connector and the female connector. The mounting is very convenient; and at the same time, the present invention can avoid unnecessary metal contact damage, so as to increase the connector's service life.

2) A plurality of metal contacts is provided on the male connector, and a plurality of corresponding holes is provided on the female connector. In comparison to the traditional male connector and female connector, which are only provided with one metal contact and one corresponding hole, the present invention is able to connect multiple lines of lights, and thus is more attractive.

3) The male connector and the female connector are removably disposed on the trunk. Accordingly, in comparison to the traditional male connector and female connector, which are formed through a solid core injection molding process, the male and female connectors can be quickly disassembled and repaired in the case when a quality issue occurs. Therefore, the use of the present invention becomes more convenient.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The drawings provided below are for the purpose of providing descriptions for the present invention, rather than limiting the scope of the present invention.

The present invention will become more fully understood from the detailed description and the accompanying drawings, wherein:

FIG. 1 is a perspective view of the structure of the present invention;

FIG. 2 is an exploded view of the structure of the present invention; and

FIG. 3 is a schematic view of the male connector according to the present invention.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Embodiments, the embodiments of the present invention will be described by providing certain examples of the present invention. A person of ordinary skill in the art can easily understand the advantages and beneficial effects of the present invention based on the contents disclosed in the Description of the present application.

In the figures, the elements have the following general numbering: male connector 10; metal contact 11; first limiting portion 12; female connector 20; hole 21; second limiting portion 22; first connecting portion 30; second connecting portion 40; and mounting hole 50.

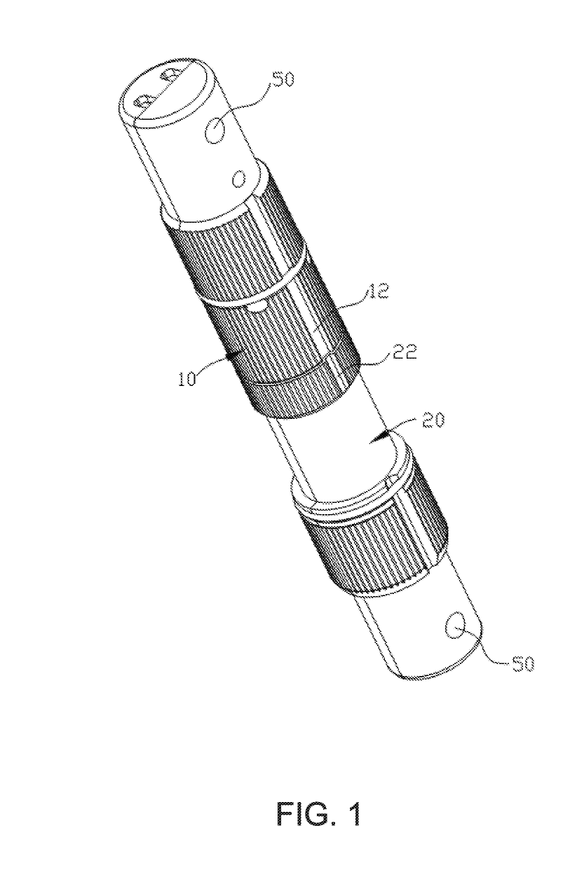

Exemplary embodiment I: As shown in FIGS. 1 to 3, a pin connector comprises a male connector 10, which is provided with a plurality of metal contacts 11; a female connector 20, which comprises a plurality of holes 21 corresponding to the plurality of metal contacts 11, wherein the male connector 10 is inserted into the female connector, and the male connector 10 is electrically connected to the female connector. As shown in FIG. 1, mounting holes 50 are respectively provided on the housing of the male connector 10 and the housing of the female connector 20, wherein the mounting holes are used for detachably mounting the male connector 10 and the female connector 20 on a tree trunk. In this embodiment, the male connector 10 and the female connector 20 are removably disposed on the trunk. Accordingly, in comparison to the traditional male connector and female connector, which are formed through a solid core injection molding process, the male and female connectors can be quickly disassembled and repaired in the case when a quality issue occurs with the male connector 10 or the female connector 20. Therefore, the use of the present invention becomes more convenient.

In reference to FIGS. 1 to 3, the connecting end of the male connector 10 is a sleeve structure with a receiving chamber, while the connecting end of the female connector 20 is a cylindrical boss structure corresponding to the sleeve structure of the male connector 10. The diameter of the cylindrical boss structure is smaller than the external diameter of the housing of the female connector 20. In addition, the metal contacts 11 are fixedly provided in the center of the sleeve structure, and the holes 21 are provided in the center of the cylindrical boss structure.

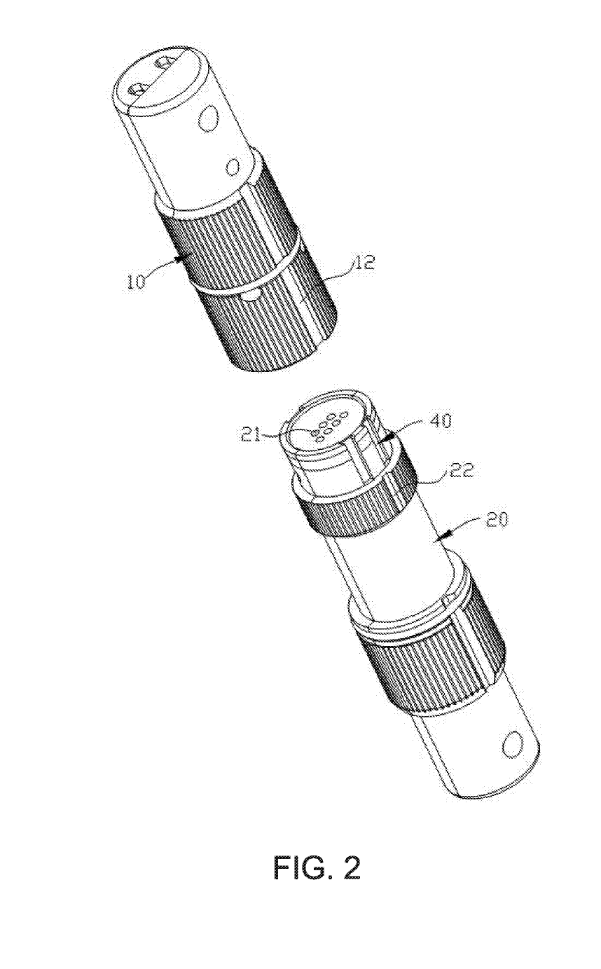

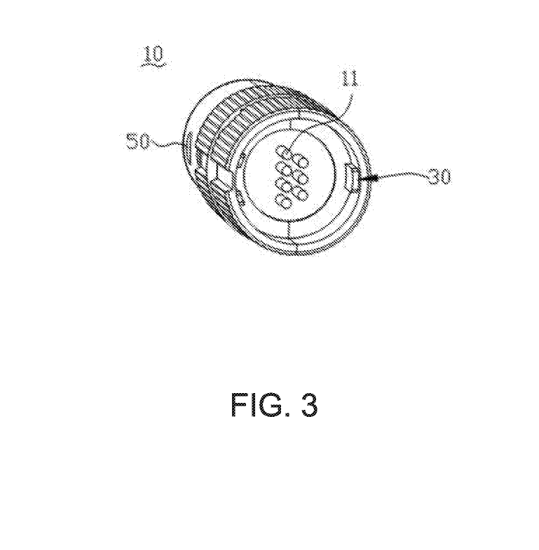

In reference to FIGS. 2 and 3, a first connecting portion 30 is provided at a connecting end of the male connector 10, a second connecting portion 40 matching the first connecting portion 30 is provided at a connecting end of the female connector 20. The first connecting portion 30 and the second connecting portion 40 provided in the present invention have two functions, one is connecting the male connector 10 and the female connector 20; and the other one is presenting the male connector 10 and the female connector 20 from rotating against each other. In addition, the external circumferential wall of the housing of the male connector 10 and the external circumferential wall of the housing of the female connector 20 are respectively provided with a first limiting portion 12 and a second limiting portion 22 to facilitate the connection of the first connecting portion 30 and the second connecting portion 40. The first limiting portion 12 and the second limiting portion 22 are straight slots respectively formed on the external circumferential wall of the housing of the male connector 10 and the external circumferential wall of the housing of the female connector 20. The specific quantities of the first limiting portion 12 and the second limiting portion 22 are determined by actual needs, and each of the two can be one, two, or more than two. It is noted that the first limiting portion 12 and the second limiting portion 22 can help to improve the accuracy when aligning the male and female connectors. However, they also increase the processing difficulty. In this regard, the quantities of the first limiting portion 12 and the second limiting portion 22 cannot be very high. It is preferably within the range of from 1 to 3. FIGS. 1 to 3 show an example when there is one first limiting portion 12 and one second limiting portion 22.

The first connecting portion 30 is a connecting block formed on the internal circumferential wall of the connecting end of the male connector 10 and extended in an axial direction, and at least one connecting block is fixedly provided on the internal circumferential wall of the connecting end of the male connector 10. The second connecting portion 40 is a connecting slot formed on the external circumferential wall of the connecting end of the female connector 20 and extended in an axial direction, and at least one connecting slot is provided on the external circumferential wall of the connecting end of the female connector 20. In addition, the connecting blocks and the connecting slots are corresponding to each other. In this exemplary embodiment, the male connector 10 has 3 connecting blocks, and correspondingly, the female connector 20 has 3 connecting slots, wherein among the 3 connecting blocks, two of them are located on the same semi-circular arc, while the third one is located on another semi-circular arc. The foregoing configuration makes the connection more reliable.

Working mechanism: when connecting the male and female connectors together, the first limiting portion 12 on the male connector 10 is aligned with the second limiting portion 22 on the female connector 20, which can facilitate a successful insertion of the first connecting portion 30 into the second connecting portion 40. In this way, the metal contacts 11 can be accurately inserted into the corresponding holes 21. So, they can be easily installed; and at the same time, the present invention can avoid unnecessary metal contact 11 damage, so as to increase the connector's service life.

Exemplary embodiment II: different from the Exemplary embodiment I, the first limiting portion 12 and the second limiting portion 22 in this embodiment have different structures. In the Exemplary embodiment II, the first limiting portion 12 and the second limiting portion 22 are straight protrusions respectively formed on the external circumferential wall of the housing of the male connector 10 and the external circumferential wall of the housing of the female connector 20.

The foregoing exemplary embodiments are for describing the present invention, rather than limiting the scope of the present invention. Without departing from the principles and mechanisms of the present invention, a skilled one in the art may make modifications on the present invention. Therefore, the scope of the present invention should be defined by the appended claims.

What is claimed is:

1. A pin connector comprising:
a male connector comprising a plurality of metal contacts;
a female connector comprising a plurality of holes corresponding to the plurality of metal contacts, wherein the male connector is inserted into the female connector, and the male connector is electrically connected to the female connector;
wherein a first connecting portion is provided at a connecting end of the male connector, a second connecting portion matching the first connecting portion is provided at a connecting end of the female connector; the external circumferential wall of the housing of the male connector and the external circumferential wall of the housing of the female connector are respectively provided with a first limiting portion and a second limiting portion to facilitate the connection of the first connecting portion and the second connecting portion.

2. The pin connector according to claim 1, wherein the first limiting portion and the second limiting portion are straight slots respectively formed on the external circumferential wall of the housing of the male connector and the external circumferential wall of the housing of the female connector.

3. The pin connector according to claim 1, wherein the first limiting portion and the second limiting portion are straight protrusions respectively formed on the external circumferential wall of the housing of the male connector and the external circumferential wall of the housing of the female connector.

4. The pin connector according to claim 1, wherein the first connecting portion is a connecting block formed on the internal circumferential wall of the connecting end of the male connector and extended in an axial direction, and at least one connecting block is fixedly provided on the internal circumferential wall of the connecting end of the male connector.

5. The pin connector according to claim 1, wherein the second connecting portion is a connecting slot formed on the external circumferential wall of the connecting end of the female connector and extended in an axial direction, and at least one connecting slot is provided on the external circumferential wall of the connecting end of the female connector.

6. The pin connector according to claim 1, wherein mounting holes are respectively provided on the housing of the male connector and the housing of the female connector, wherein the mounting holes are used for detachably mounting the male connector and the female connector on a tree trunk.
